(19) United States
(12) Patent Application Publication
(10) Pub. No.: US 2022/0367887 A1
(43) Pub. Date: Nov. 17, 2022

(54) THIN RESIN SHEET MEMBER AND METHOD FOR MANUFACTURING THE SAME

(71) Applicants: SHIMIZU INDUSTRY CO., LTD., Aichi (JP); TOAGOSEI CO., LTD., Tokyo (JP)

(72) Inventors: Yoichi IKEHARA, Aichi (JP); Atsushi TSUTSUMI, Aichi (JP); Tomohiro KITADE, Aichi (JP); Hiroki ASAKAWA, Aichi (JP); Naoki TANIZAWA, Aichi (JP); Hiroyuki YAMAGA, Aichi (JP)

(21) Appl. No.: 17/773,565

(22) PCT Filed: Oct. 30, 2020
(86) PCT No.: PCT/JP2020/040911

§ 371 Date: Apr. 29, 2022

(30) Foreign Application Priority Data
Nov. 1, 2019 (JP) 2019-199706

(51) Int. Cl. H01M 8/0284; B29D 7/01; B29C 45/37; B29C 45/27; B29C 45/00; H01M 8/0276

(52) U.S. Cl. CPC H01M 8/0284; B29D 7/01; B29C 45/37; B29C 45/27; B29C 45/0001; H01M 8/0276; B29K 2101/12

(57) ABSTRACT

A sheet member includes a pair of main surfaces opposing each other. A maximum thickness that is a maximum interval between the pair of main surfaces is 40 μm or more and 450 μm or less. The sheet member has a region in which a plurality of coherent pattern lines appear when viewed from a direction facing the pair of main surfaces, the plurality of coherent pattern lines being arranged at intervals in a direction in which one edge portion and another edge portion opposing the one edge portion oppose each other, and a pair in the plurality of coherent pattern lines adjacent to each other do not intersect.

### TECHNICAL FIELD

The present invention relates to a thin resin sheet member and a method for manufacturing the same.

### BACKGROUND ART

As a method for manufacturing a fuel cell gasket which is an example of a thin resin sheet member, it is known that an extruded thin resin film is formed into a desired shape by press working. Patent Document 1 discloses a manufacture of a fuel cell gasket by injection molding.

### PRIOR ART DOCUMENT

### Patent Document

Patent Document 1: JP 2016-207445 A

### SUMMARY OT THE INVENTION

### Problems to be Solved by the Invention

A fuel cell gasket manufactured by press working on a thin resin film obtained by extrusion molding is inferior in dimensional stability.

A fuel cell gasket preferably has a small thickness from the viewpoint of downsizing a fuel cell. However, the fuel cell gasket manufactured by injection molding disclosed in Patent Document 1 has a minimum thickness of 0.2 mm, and there is room for further reducing the thickness.

An object of the present invention is to provide a thin resin sheet member made of thin resin having good dimensional stability.

### Means for Solving the Problems

A first aspect of the present invention is a thin resin sheet member including a pair of main surfaces opposing each other, wherein the thin resin sheet member has a maximum thickness of 40 μm or more and 450 μm or less, the maximum thickness being a maximum interval between the pair of main surfaces, and the thin resin sheet member has a region in which a plurality of coherent pattern lines appear when viewed from a direction facing the pair of main surfaces, the plurality of coherent pattern lines being arranged at intervals in a direction in which one edge portion and another edge portion opposing the one edge portion oppose each other, and a pair in the plurality of coherent pattern lines adjacent to each other do not intersect.

Specifically, the region is 50% or more of a total area of the pair of main surfaces.

The thin resin sheet member having a region in which the regular coherent pattern lines appear as described above is not attributed to a manufacture by press working on an extruded thin resin film but attributed to a manufacture by injection molding of an aspect as described later, that is, by the injection molding according to the manufacturing method of the second aspect. The thin resin sheet member of the present invention manufactured by such injection molding has excellent dimensional stability as compared with a thin resin sheet member made of extruded thin resin film.

The thin resin sheet member according to the present invention has a maximum thickness of 40 μm or more and 450 μm or less, that is, the sheet member is further thinned than a thin resin sheet member manufactured by conventional injection molding. Therefore, the thin resin sheet member according to the present invention can contribute to downsizing of a fuel cell when the sheet member is used as a fuel cell gasket.

A second aspect of the present invention is a method for manufacturing a thin resin sheet member, the method including preparing a forming mold defining a cavity including a product portion in which a thin resin sheet member is molded, a gate/runner portion communicating with a molding machine injection unit, and a land portion communicating with the gate/runner portion and communicating with one edge portion of the product portion, wherein the land portion has a thickness larger than a thickness of the product portion, and supplying a molten resin from the molding machine injection unit to the gate/runner portion, wherein after the molten resin fills the land portion, the molten resin flows from the one edge portion into the product portion and flows toward another edge portion opposing the one edge portion of the product portion.

After the molten resin fills the land portion, the molten resin flows from one edge portion of the product portion into the product portion, and flows toward another edge portion opposing the one edge portion of the product portion. As a result, the resin flows in one direction from one edge portion to the other edge portion in the product portion, and the orientation of the resin is aligned in this flow direction. With the orientation of the resin being aligned like this, a thin resin sheet member having excellent dimensional stability is obtained as compared with a thin resin sheet member made of extruded thin resin film.

In the thin resin sheet member obtained by the manufacturing method of the second aspect of the present invention, the orientation of the resin is aligned in one direction as described above. Therefore, the thin resin sheet member has a region in which a plurality of coherent pattern lines arranged at intervals in the direction in which the resin is oriented, that is, in the direction in which one edge portion of the product portion and another edge portion opposing the one edge portion oppose each other (direction in which one edge portion of the thin resin sheet member and another edge portion opposing the one edge portion oppose each other) appear, and a pair in the coherent pattern lines adjacent to each other do not intersect.

The thickness of the land portion may be set to 1.3 times or more and 24 times or less the thickness of the product portion.

The average thickness of the land portion may be set to 300 μm or more and 1200 μm or less.

The land portion may communicate with an entire region of an inner peripheral edge portion of the product portion, and after the molten resin fills the land portion, the molten resin may flow from the inner peripheral edge portion into the product portion and flow toward an outer peripheral edge portion of the product portion.

The land portion may communicate with an entire region of an outer peripheral edge portion of the product portion, and after the molten resin fills the land portion, the molten resin may flow from the outer peripheral edge portion into the product portion and flow toward an inner peripheral edge portion of the product portion.

The product portion may have an outer peripheral edge portion including a plurality of edge portions, the land portion may communicate with one edge portion constituting a part of the outer peripheral edge portion of the product portion, and after the molten resin fills the land portion, the molten resin may flow from the one edge portion toward another edge portion opposing the one edge portion constituting a part of the outer peripheral edge portion.

The resin may be a thermoplastic resin having a melt mass flow rate of 10 g/10 min or more and 300 g/10 min or less and a heat of fusion of 0 mj/mg or more and 150 mj/mg or less.

### Effect of the Invention

According to the present invention, a thin resin sheet member having good dimensional stability that is thinned to have a maximum thickness of 40 μm or more and 450 μm or less is obtained.

### BRIEF DESCRIPTION OF THE DRAWINGS

FIG. 1 is a schematic perspective view of a sheet member (fuel cell gasket) according to a first embodiment of the present invention;

FIG. 2 is a photograph of a part of FIG. 1;

FIG. 3 is a schematic plan view of a forming mold for manufacturing the sheet member according to the first embodiment;

FIG. 4 is a cross-sectional view taken along the line IV-IV in FIG. 3;

FIG. 5 is a schematic plan view of a lower mold for explaining an orientation of a resin in injection molding;

FIG. 6 is a schematic plan view of a sheet member when taken out from a forming mold;

FIG. 7 is a cross-sectional view taken along the line VII-VII in FIG. 6;

FIG. 8 is a cross-sectional view similar to FIG. 4, of another example of a forming mold that can be used for manufacturing the sheet member of the first embodiment;

FIG. 9 is a schematic plan view similar to FIG. 5, of another forming mold (lower mold) that can be used for manufacturing the sheet member of the first embodiment;

FIG. 10 is a schematic plan view of a sheet member when taken out from the forming mold of FIG. 9;

FIG. 11 is a cross-sectional view taken along the line XI-XI in FIG. 10;

FIG. 12 is a schematic plan view similar to FIG. 5, of another forming mold (lower mold) that can be used for manufacturing the sheet member of the first embodiment;

FIG. 13 is a schematic plan view of the sheet member when taken out from the forming mold of FIG. 12;

FIG. 14 is a cross-sectional view similar to FIG. 4, of another example of a forming mold that can be used for manufacturing the sheet member of the first embodiment;

FIG. 15 is a schematic plan view of the sheet member when taken out from the forming mold of FIG. 14;

FIG. 16 is a cross-sectional view taken along the line XVI-XVI in FIG. 14;

FIG. 17 is a cross-sectional view similar to FIG. 14 showing an alternative of a land portion;

FIG. 18 is a cross-sectional view similar to FIG. 14 showing an alternative of a land portion;

FIG. 19 is a schematic perspective view of a sheet member according to a second embodiment of the present invention;

FIG. 20 is a schematic plan view similar to FIG. 5, of a forming mold (lower mold) that can be used for manufacturing the sheet member of the second embodiment;

FIG. 21 is a schematic plan view of the sheet member when taken out from the forming mold of FIG. 20;

FIG. 22 is a schematic plan view similar to FIG. 5, of another forming mold (lower mold) that can be used for manufacturing the sheet member of the second embodiment;

FIG. 23 is a schematic plan view of the sheet member when taken out from the forming mold of FIG. 22;

FIG. 24 is a schematic perspective view of a sheet member according to a third embodiment of the present invention;

FIG. 25 is a schematic plan view of a forming mold for manufacturing the sheet member according to the third embodiment;

FIG. 26 is a cross-sectional view taken along the line XXVI-XXVI in FIG. 25;

FIG. 27 is a schematic plan view similar to FIG. 5, of a forming mold (lower mold) that can be used for manufacturing the sheet member of the third embodiment;

FIG. 28 is a schematic plan view of the sheet member when taken out from the forming mold of FIG. 27;

FIG. 29 is a cross-sectional view taken along the line XXIX-XXIX in FIG. 28;

FIG. 30 is a schematic plan view of another forming mold for manufacturing the sheet member according to the third embodiment;

FIG. 31 is a cross-sectional view taken along the line XXXI-XXXI in FIG. 30;

FIG. 32 is a schematic plan view of the sheet member when taken out from the forming mold of FIG. 31;

FIG. 33 is a cross-sectional view taken along the line XXXIII-XXXIII in FIG. 32;

FIG. 34 is a schematic perspective view of a sheet member according to a fourth embodiment of the present invention;

FIG. 35 is a schematic plan view of a forming mold for manufacturing the sheet member according to the fourth embodiment;

FIG. 36 is a cross-sectional view taken along the line XXXVI-XXXVI in FIG. 35;

FIG. 37 is a schematic plan view similar to FIG. 5, of a forming mold (lower mold) that can be used for manufacturing the sheet member of the fourth embodiment;

FIG. 38 is a schematic plan view of the sheet member when taken out from the forming mold of FIG. 37;

FIG. 39 is a cross-sectional view taken along the line XXXIX-XXXIX in FIG. 38;

FIG. 40 is a schematic plan view of a sheet member according to a modification of the fourth embodiment;

FIG. 41 is a schematic plan view of a sheet member according to another modification of the fourth embodiment;

FIG. 42 is a schematic perspective view of a sheet member according to a fifth embodiment of the present invention;

FIG. 43 is a schematic plan view similar to FIG. 5, of a forming mold (lower mold) that can be used for manufacturing the sheet member of the fifth embodiment;

FIG. 44 is a schematic plan view of the sheet member when taken out from the forming mold of FIG. 43;

FIG. 45 is a schematic perspective view of a sheet member according to a modification of the fifth embodiment;

FIG. 46 is a schematic perspective view of a sheet member according to a sixth embodiment of the present invention;

FIG. 47 is a schematic plan view of a forming mold for manufacturing a sheet member according to a sixth embodiment;

FIG. 48 is a cross-sectional view taken along the line XXXXVIII-XXXXVIII in FIG. 47;

FIG. 49 is a schematic plan view of the sheet member when taken out from the forming mold of FIG. 48;

FIG. 50 is a cross-sectional view taken along the line L-L in FIG. 49;

FIG. 51 is a schematic perspective view of a sheet member according to a seventh embodiment of the present invention;

FIG. 52 is a schematic plan view of a forming mold for manufacturing the sheet member according to the seventh embodiment;

FIG. 53 is a cross-sectional view taken along the line LIII-LIII in FIG. 42;

FIG. 54 is a schematic plan view similar to FIG. 5, of a forming mold (lower mold) that can be used for manufacturing the sheet member of the seventh embodiment;

FIG. 55 is a schematic plan view of the sheet member when taken out from the forming mold of FIG. 49;

FIG. 56 is a schematic perspective view of a sheet member according to an eighth embodiment of the present invention;

FIG. 57 is a schematic plan view of a forming mold for manufacturing the sheet member according to the eighth embodiment;

FIG. 58 is a cross-sectional view taken along the line LVII-LVII in FIG. 57;

FIG. 59 is a schematic plan view similar to FIG. 5, of a forming mold (lower mold) that can be used for manufacturing the sheet member of the eighth embodiment;

FIG. 60 is a schematic plan view of the sheet member when taken out from the forming mold of FIG. 59;

FIG. 61 is a schematic plan view of a gasket used in an evaluation test;

FIG. 62 is a schematic plan view of a comparative example used in an evaluation test.

### DESCRIPTION OF EMBODIMENTS

Hereinafter, embodiments of the present invention will be described with reference to the accompanying drawings.

### First Embodiment

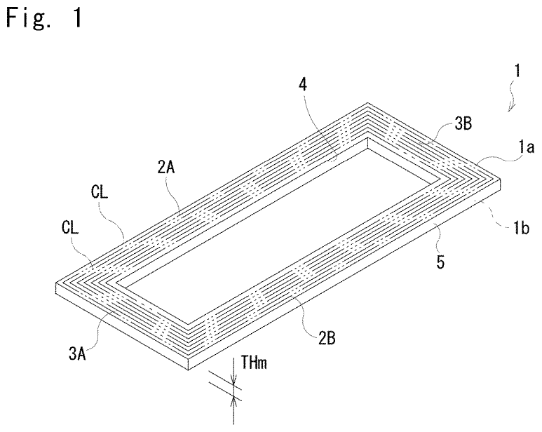

FIG. 1 shows a thin resin sheet member 1 (hereinafter, simply referred to as sheet member 1) according to a first embodiment of the present invention. The sheet member 1 of the present embodiment is a fuel cell gasket.

As described later, the sheet member 1 is manufactured by injection molding of a thermoplastic resin.

The sheet member 1 has two opposing surfaces having an area sufficiently larger than the other surfaces, that is, a pair of main surfaces 1a and 1b. In the present embodiment, the interval between the main surfaces 1a and 1b, that is, a thickness THm of the sheet member 1 is constant or uniform. The sheet member 1 (gasket) is thinner than a gasket manufactured by conventional injection molding. That is, the thickness THm of the sheet member 1 is set to 40 μm or more and 450 μm or less. The thickness THm of the sheet member 1 is preferably set to 50 μm or more and 350 μm or less, and more preferably 100 μm or more and less than 200 μm. The thickness THm of the sheet member 1 is not necessarily uniform. That is, different portions of the sheet member 1 may have different thicknesses THm. When the thickness THm of the sheet member 1 is not uniform, the maximum thickness, that is, the maximum value (maximum interval between main surfaces 1a and 1b) of the thickness THm is set to 40 μm or more and 450 μm or less, preferably 50 μm or more and 350 μm or less, and more preferably 100 μm or more and less than 200 μm.

The overall shape of the sheet member 1 of the present embodiment is a flat rectangular frame shape and includes a pair of longer portions 2A and 2B extending in the longer direction of the sheet member 1 and a pair of shorter portions 3A and 3B extending in the shorter direction of the sheet member 1 and connecting end portions of the longer portions 2A and 2B, respectively. The sheet member 1 of the present embodiment includes an inner peripheral edge portion 4 and an outer peripheral edge portion 5 each having a rectangular shape when viewed from a direction facing the main surfaces 2a and 2b.

Next, a method for manufacturing the sheet member 1 of the present embodiment (injection molding method) will be described.

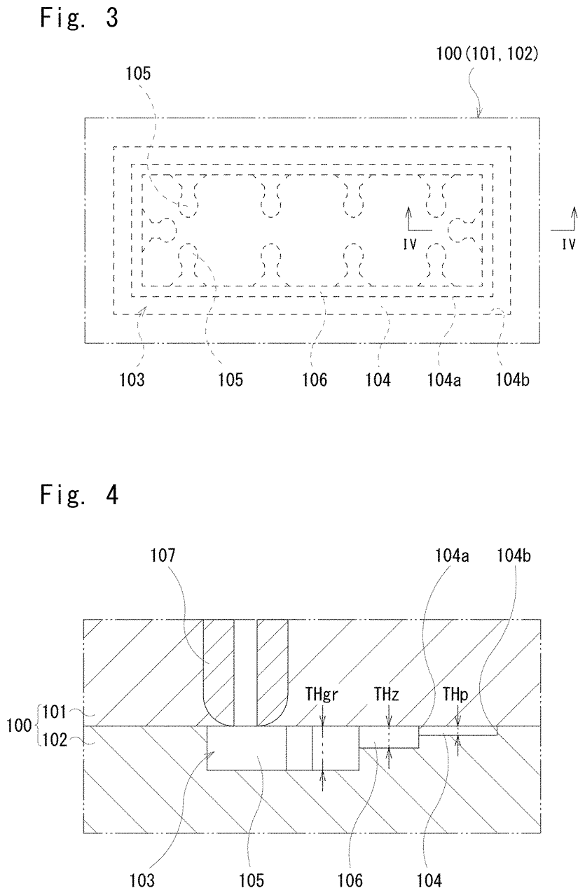

In FIGS. 3 to 5, in the present embodiment, a forming mold 100 for injection molding the sheet member 1 includes an upper mold 101 and a lower mold 102. In the present embodiment, a cavity 103 defined by the upper mold 101 and the lower mold 102 includes one product portion 104, a plurality (10) of gate/runner portions 105, and one land portion 106.

The product portion 104 is a portion where the sheet member 1 is to be molded and has substantially the same size and shape as those of the sheet member 1. In particular, the product portion 104 has an inner peripheral edge portion 104a and an outer peripheral edge portion 104b corresponding to the inner peripheral edge portion 4 and the outer peripheral edge portion 5 of the sheet member 1, respectively. Both the inner peripheral edge portion 104a and the outer peripheral edge portion have a rectangular shape in plan view. A thickness THp of the product portion 104 is substantially the same as the thickness THm of the sheet member 1. That is, the maximum value of the thickness THp of the product portion 104 is set to 40 μm or more and 450 μm or less, preferably 50 μm or more and 350 μm or less, and more preferably 100 μm or more and less than 200 μm.

In the present embodiment, the gate/runner portions 105 are arranged inside the product portion 104 in plan view.

Each gate/runner portion 105 fluidically communicates with a molding machine injection unit (not shown) via a spool mechanism 107 provided in the upper mold 101. A molten thermoplastic resin is supplied from the molding machine injection unit to the gate/runner portion 105. The spool mechanism 107 supplies the thermoplastic resin to the gate/runner portion 105 only when the upper mold 101 and the lower mold 102 are clamped. Therefore, a trace corresponding to the shape of an outlet hole of the spool mechanism 107 remains in a second non-product portion 109 described later.

Each gate/runner portion 105 fluidically communicates with the land portion 106.

In the present embodiment, the land portion 106 is arranged inside the product portion 104 in plan view. The land portion 106 is interposed between the gate/runner portions 105 and the product portion 104. The land portion 106 has a rectangular shape in plan view and communicates with the entire region of the inner peripheral edge portion of the product portion 104.

The thickness THz of the land portion 106 is larger than the thickness THp of the product portion 104. For example, the thickness THz of the land portion 106 is set to 1.3 times or more and 24 times or less, preferably 2.5 times or more and 10 times or less the thickness THp of the product portion 104. The thickness THz of the land portion 106 is set to be equal to or less than the thickness THgr of the gate/runner portion 105. For example, the thickness TH of the land portion 106 is set to 0.12 times or more and 1.0 times or less the thickness THgr of the gate/runner portion 105. The thickness THp of the product portion 104, the thickness THz of the land portion 106, and the thickness THgr (average thickness) of the gate/runner portion 105 are set to satisfy the relationship of the following Formula (1).

THp<THz≤THgr (1)

The thickness THz of the land portion 106 satisfies the above conditions and is set to 300 μm or more and 1200 μm or less, preferably 500 μm or more and 1000 μm or less in terms of an average thickness. In the present embodiment, the thickness THz of the land portion 106 is constant, and the average thickness is set to 500 μm. In the present embodiment, the thickness THz of the land portion 106 is three times the thickness THp of the product portion 104.

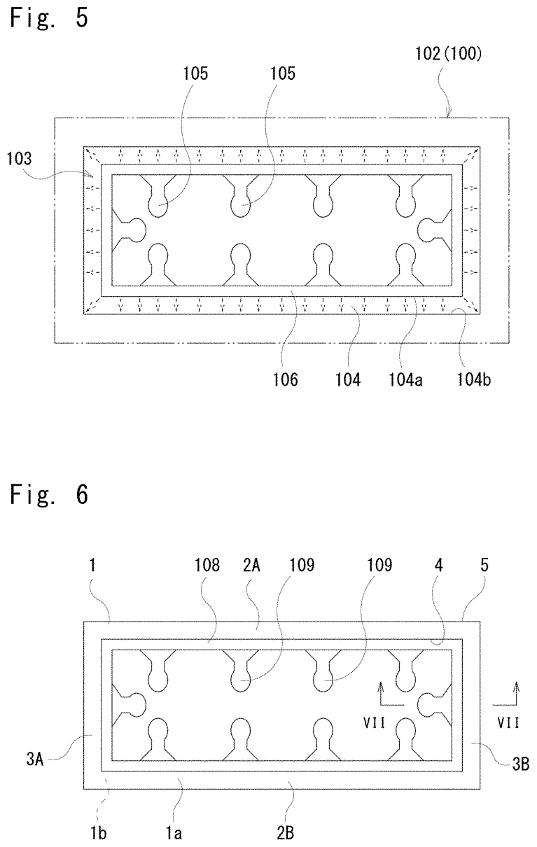

The molten thermoplastic resin supplied from the molding machine injection unit to the gate/runner portion 105 flows into the land portion 106, but the thermoplastic resin does not substantially flow into the product portion 104 until the land portion 106 is filled with the thermoplastic resin, that is, until the entire volume of the land portion 106 is occupied by the thermoplastic resin. When the molten thermoplastic resin is further supplied from the gate/runner portion 105 to the land portion 106 in a state where the entire volume of the land portion 106 is occupied by the thermoplastic resin, the molten thermoplastic resin simultaneously flows from the land portion 106 into the product portion 104 as indicated by broken line arrows in FIG. 5. More specifically, as indicated by broken line arrows in FIG. 5, the molten thermoplastic resin flows in one direction from the inner peripheral edge portion 104a toward the outer peripheral edge portion 104b of the product portion 104.

The land portion 106 functions as a portion for storing the molten thermoplastic resin in order to uniformly flow the required resin in one direction into the product portion 104. The thermoplastic resin needs to flow into the entire land portion 106 in preference to the inflow into the product portion 104. By setting the thickness THz of the land portion 106 to be thicker than the thickness THp of the product portion 104 as described above, the inflow of the thermoplastic resin of such an aspect is realized. When the inflow of the thermoplastic resin into the land portion 106 is completed, the internal pressure of the forming mold 100 increases, and the thermoplastic resin can flow from the land portion 106 into the product portion 104 having a smaller thickness. To realize such a uniform molten resin inflow state, the temperature of the forming mold 100 is preferably maintained at 20° C. or more and 80° C. or less, and preferably 40° C. or more and 80° C. or less. In the present embodiment, the temperature of the forming mold 100 is maintained at 40° C. or more and 50° C. or less. A cooling hole may be provided in the forming mold 100 (upper mold 101, lower mold 102) to maintain an appropriate temperature.

To realize the inflow state as described above, the thermoplastic resin preferably has a melt mass flow rate (measurement conditions: JIS K 7210 230° C., 2.16 kg) of 10 g/10 min or more and 300 g/10 min or less and a heat of fusion of 0 mj/mg or more and 150 mj/mg or less, preferably 50 mj/mg or more and 110 mj/mg or less.

Table 1 below shows examples of thermoplastic resins that can be employed.

TABLE 1

| | Melting | Mold |
|---|---|---|
| | temperature | temperature |
| Thermoplastic resin | (° C.) | (° C.) |
| Polypropylene (PP) | 140-220 | 20-80 |
| Polyethylene (PE) | 140-200 | 20-70 |
| Polybutylene terephthalate (PBT) | 250 | 80 |
| Polyethylene terephthalate (PET) | 250-290 | 90-120 |
| Polycarbonate (PC) | 270-370 | 50-130 |
| Polyamide (PA) | 240-300 | 50-140 |
| Polyacetal (POM) | 180-240 | 60-140 |
| Polyketone (POK) | 240-250 | 60-80 |
| Polysulfone (PSU) | 360-390 | 138-163 |
| Polyphenyl sulfone (PPSU) | 350-380 | 105-160 |
| Polyether sulfone (PES) | 345-385 | 138-160 |
| Polyphenylene sulfide (PPS) | 300-350 | 135-180 |
| Polyetherimide (PEI) | 355-390 | 130-160 |
| Polyetheretherketone (PEEK) | 365-380 | 175-205 |
| Modified polyphenyleneether (m-PPE) | 250-300 | 50-110 |
| Ethylene-vinyl acetate copolymer (EVA | 130-190 | 20-55 |
| resin) | | |
| Cyclic olefin copolymer (COC) | 260-280 | 80-90 |

The orientation of the thermoplastic resin is aligned in the flow direction of the thermoplastic resin as described above (broken line arrows in FIG. 5). With the orientation of the thermoplastic resin being aligned like this, the sheet member 1 having excellent dimensional stability is obtained as compared with a thin resin sheet member made of extruded thin resin film.

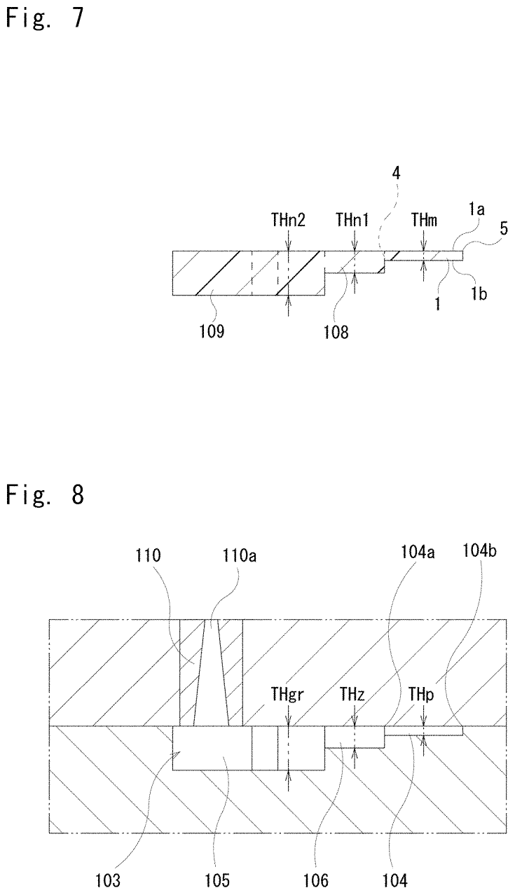

FIGS. 6 and 7 show the sheet member 1 taken out from the forming mold 100 after completion of injection molding. A first non-product portion 108 having a rectangular frame shape and corresponding to the land portion 106 is formed inside the sheet member 1, and a second non-product portion 109 corresponding to the gate/runner portion 105 is formed further inside the first non-product portion 108. The first non-product portion 108 has a thickness THn1 corresponding to the thickness THz of the land portion 106, and the second non-product portion 109 has a thickness THn2 corresponding to the thickness THgr of the gate/runner portion 105. By removing the first non-product portion 108 and the second non-product portion 109 by means such as cutting, the manufacturing of the sheet member 1 is completed.

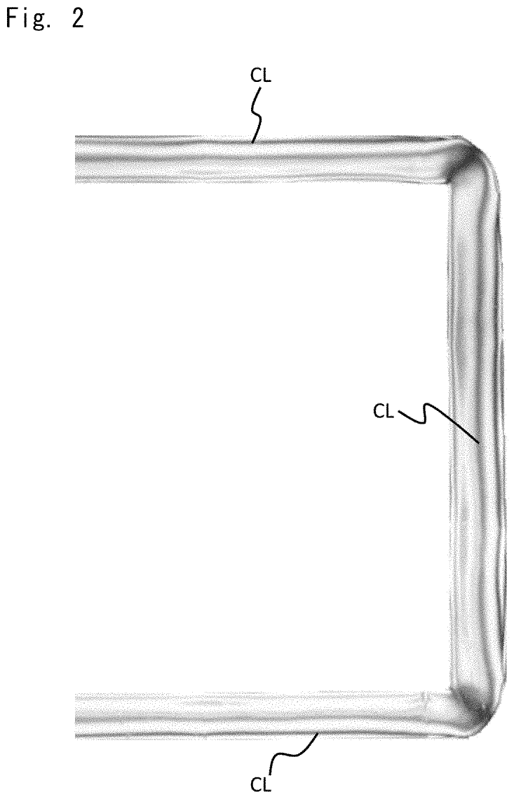

As described above, with the orientation of the thermoplastic resin being aligned in the flow direction of the thermoplastic resin (broken line arrows in FIG. 5) in the product portion 104 of the cavity 103, regular coherent pattern lines appear in the sheet member 1. This coherent pattern lines can be observed by irradiating the sheet member 1 with illumination light. Specifically, in the sheet member 1, a plurality of coherent pattern lines CL conceptually indicated by two-dot chain lines in FIG. 1 appear corresponding to the flow direction (orientation direction of the thermoplastic resin) of the thermoplastic resin indicated by broken line arrows in FIG. 5. FIG. 2 is a photograph of a part of FIG. 1, in which the coherent pattern lines CL appear. In the present embodiment, when the sheet member 1 is viewed from the direction facing the main surfaces 2a and 2b, a plurality of coherent pattern lines CL arranged at intervals in the direction in which the inner peripheral edge portion 4 and the outer peripheral edge portion 5 oppose each other appear in both the longer portions 2A and 2B and the shorter portions 3A and 3B. A pair in the coherent pattern lines CL adjacent to each other do not intersect.

The sheet member 1 of the present embodiment having a region in which the regular coherent pattern lines CL appear as described above is not attributed to the manufacture by press working on an extruded thin resin film but attributed to the manufacture by injection molding as described above. That is, it can be said that the appearance of the regular coherent pattern lines CL as described above indirectly indicates that the orientation of the thermoplastic resin is aligned and the sheet member 1 manufactured by injection molding as described above has excellent dimensional stability as compared with a thin resin sheet member made of extruded thin resin film.

Because the sheet member 1 (gasket) is manufactured by injection molding such that the orientation direction of the thermoplastic resin is aligned as described above, the sheet member 1 has excellent dimensional stability as compared with a gasket made of extruded thin resin film. The thickness THm of the sheet member 1 (gasket) is 40 μm or more and 450 μm or less, preferably 50 μm or more and 350 μm or less, and more preferably 100 μm or more and less than 200 μm, which is further thinned than a gasket manufactured by conventional injection molding. Therefore, using the sheet member 1 of the present embodiment as a gasket enables downsizing of a fuel cell.

As described above, the sheet member 1 of the present embodiment has excellent dimensional stability because the orientation direction of the thermoplastic resin is aligned. However, the orientation direction of the thermoplastic resin is not necessarily aligned in the entire region of the sheet member 1. In other words, the entire main surfaces 1a and 1b are not necessarily the regions in which the plurality of coherent pattern lines CL are arranged at intervals in the direction in which the inner peripheral edge portion 4 and the outer peripheral edge portion 5 oppose each other as described above, and the adjacent coherent pattern lines CL do not intersect each other. When such a region is 50% or more, preferably 70% or more of the total area of the main surfaces 1a and 1b, the dimensional stability because of the alignment of the orientation direction of the thermoplastic resin can improve.

FIGS. 8 to 18 show modifications of the first embodiment. These embodiments can also be applied to second to eighth embodiments described later.

In the modification of FIG. 8, a spool bush 110 in which a spool 110a is formed is attached to the upper mold 101. That is, the forming mold 100 in this modification is a so-called direct spool mold. In the present modification, an elongated conical trace corresponding to the spool 110a remains in the second non-product portion 109.

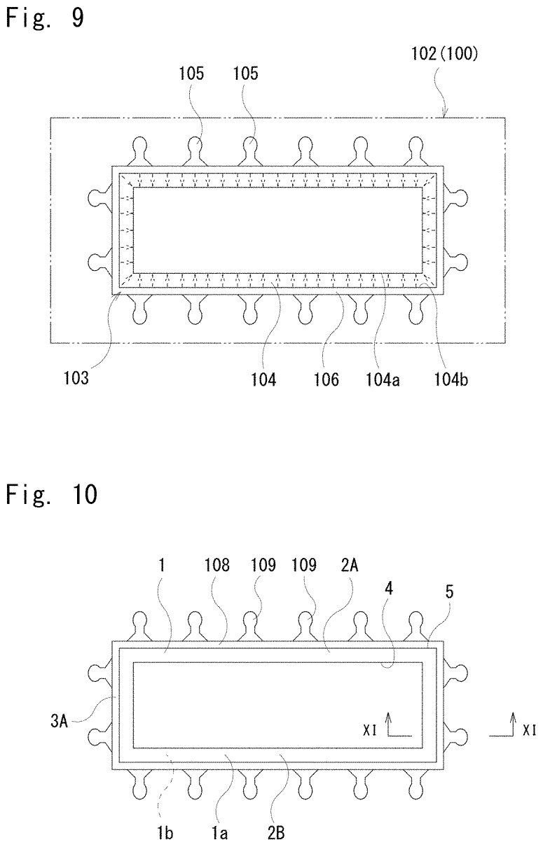

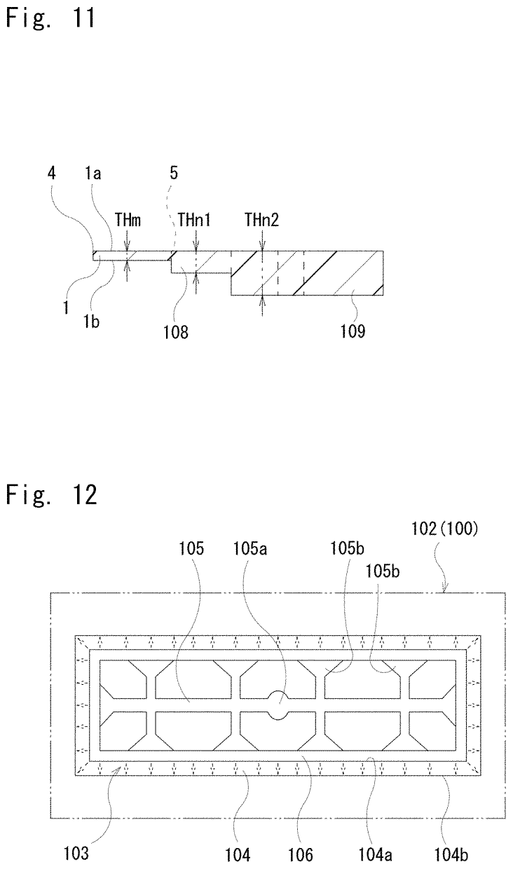

In the modification of FIG. 9, the cavity 103 defined by the forming mold 100 includes the land portion 106 arranged outside the product portion 104 and a plurality of gate/runner portions 105 arranged outside the land portion 106. In injection molding, the molten thermoplastic resin flows in one direction from the outer peripheral edge portion 104a toward the inner peripheral edge portion 104b of the product portion 104 as indicated by broken line arrows in FIG. 9. As shown in FIGS. 10 and 11, in the sheet member 1 taken out from the forming mold 100 after completion of injection molding, the first non-product portion 108 corresponding to the land portion 106 is formed outside the product portion 104, and the second non-product portion 109 corresponding to the gate/runner portion 105 is formed outside the first non-product portion 108.

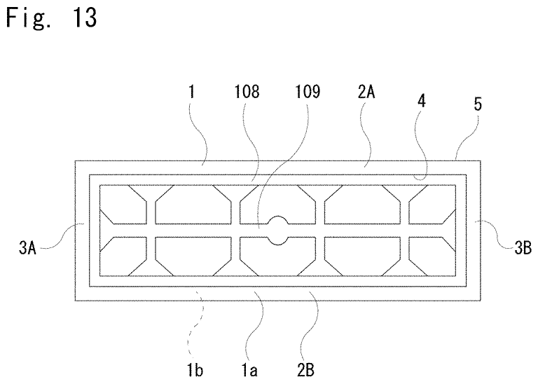

In the modification shown in FIGS. 12 and 13, the gate/runner portion 105 includes a portion opposing the spool mechanism 107 or the spool bush 110, that is, one gate portion 105a into which a molten thermoplastic resin flows, inside the land portion 106. In addition, the gate/runner portion 105 in the present embodiment includes a plurality of runner portions 105b branched from the gate portion 105a and connected to the land portion 106.

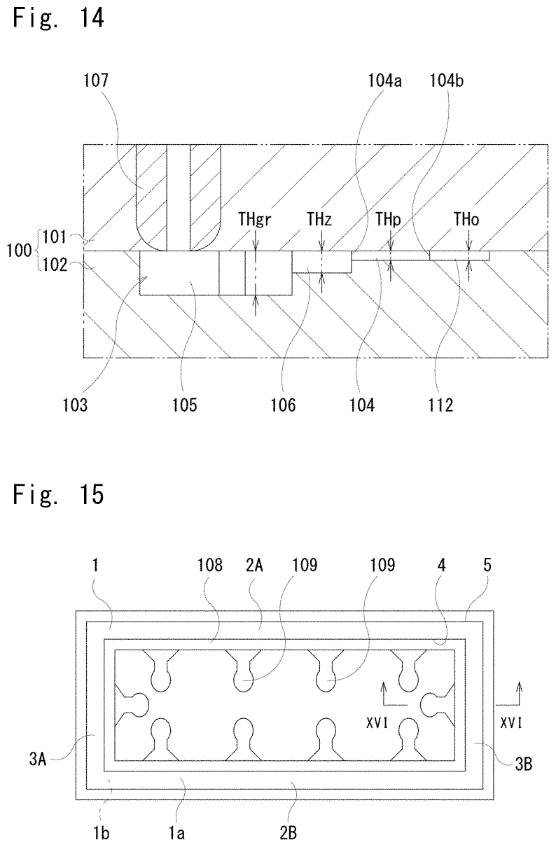

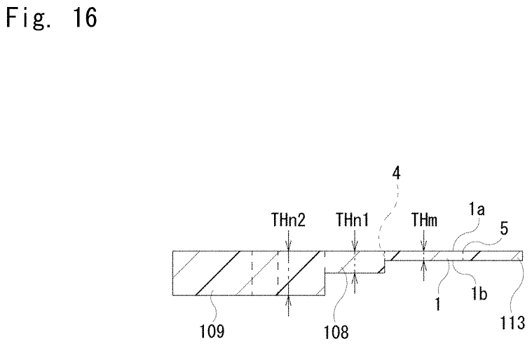

In the modification shown in FIG. 14, an overflow portion 112 is provided in the cavity 103 in such a manner as to surround the entire region of the outer side of the product portion 106. Therefore, as shown in FIGS. 15 and 16, in a state of being taken out from the forming mold 100 after injection molding, a third non-product portion 113 is formed in such a manner as to surround the entire region of the outer side of the product portion 104. The third non-product portion 113 is removed from the sheet member 1 by means such as cutting similarly to the first and second non-product portions 108 and 109. In the present embodiment, a thickness THo of the overflow portion 112 is set to be the same as the thickness THp of the product portion 106. By providing the overflow portion 112, it is possible to prevent a portion not locally filled with the thermoplastic resin from being generated in the product portion 106.

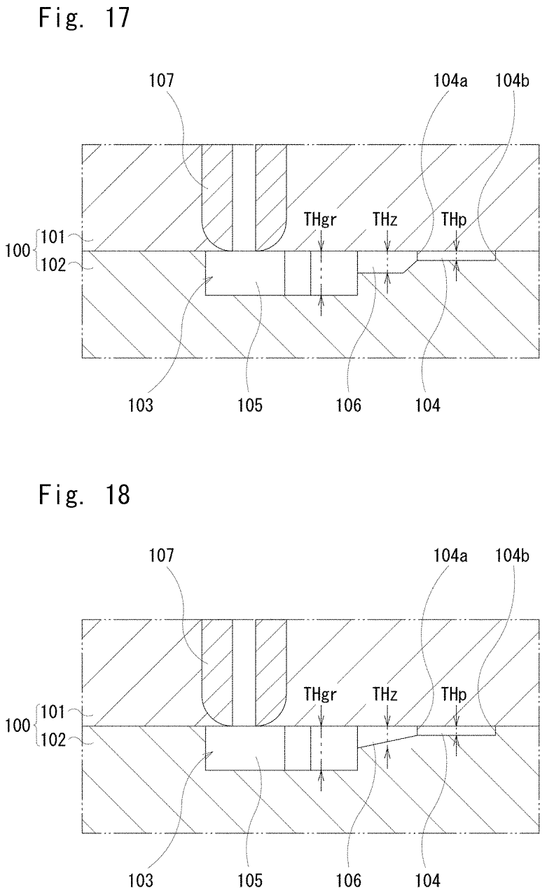

In the modification shown in FIG. 17, the thickness THz is constant in the portion on the gate/runner portion 105 side of the land portion 106, but the thickness THz gradually decreases toward the product portion 104 in the portion of the land portion 106 connected to the product portion 104. In the modification shown in FIG. 18, the thickness THz of the land portion 106 gradually decreases from the portion connected to the gate/runner portion 105 toward the portion connected to the product portion 104.

Hereinafter, second to eighth embodiments of the present invention will be described. The matters not particularly mentioned in these embodiments are the same as those in the first embodiment. In the drawings of these embodiments, the same or similar elements as those of the first embodiment are denoted by the same reference numerals.

### Second Embodiment

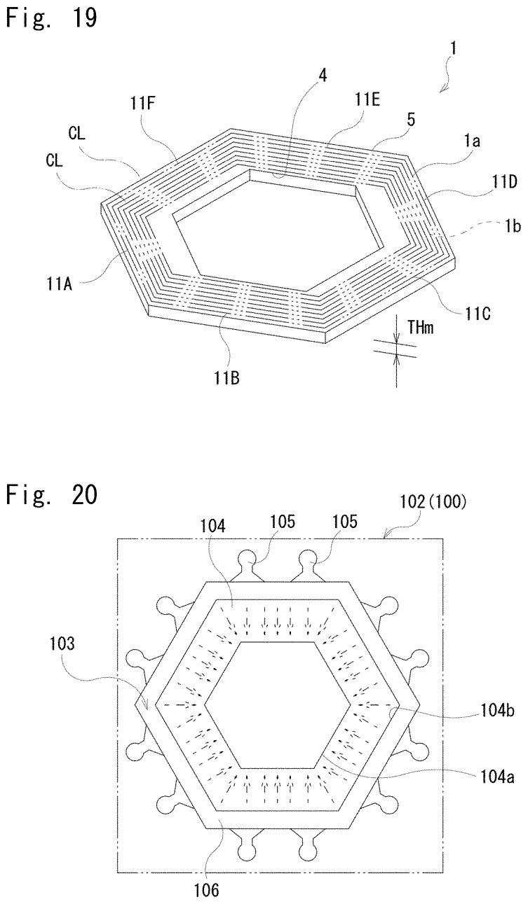

FIG. 19 shows a sheet member 1 according to a second embodiment of the present invention.

The sheet member 1 of the present embodiment has a hexagonal shape as its overall shape, and includes six straight side portions 11A, 11B, 11C, 11D, 11E, and 11F.

In FIG. 20, the forming mold 100 according to the present embodiment is provided with the land portion 106 having a hexagonal shape outside the product portion 104 having a hexagonal shape in plan view. Two gate/runner portions 105 are provided outside each portion corresponding to the side portions 11A to 11F of the land portion 106. The molten thermoplastic resin supplied from the molding machine injection unit to the gate/runner portion 105 fills the land portion 106, and then simultaneously flows from the land portion 106 into the product portion 104 as indicated by broken line arrows in FIG. 20. More specifically, as indicated by broken line arrows in FIG. 20, the molten thermoplastic resin flows in one direction from the outer peripheral edge portion 104b toward the inner peripheral edge portion 104a of the product portion 104.

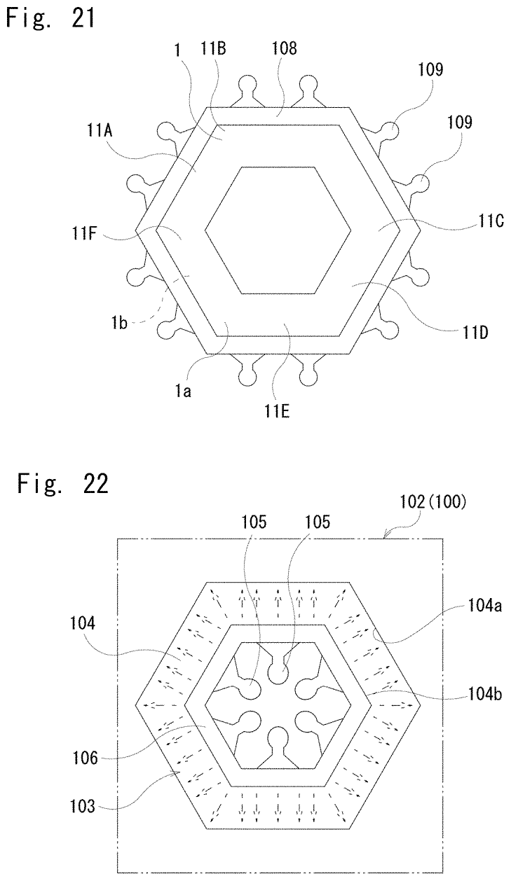

FIG. 21 shows the sheet member 1 taken out from the forming mold 100 after completion of injection molding. The first non-product portion 108 having a hexagonal shape and corresponding to the land portion 106 is formed outside the sheet member 1, and the second non-product portion 109 corresponding to the gate/runner portion 105 is formed further outside the first non-product portion 108.

With the orientation of the thermoplastic resin being aligned in the flow direction of the thermoplastic resin (broken line arrows in FIG. 20) in the product portion 104 of the cavity 103, a plurality of coherent pattern lines CL conceptually indicated by two-dot chain lines in FIG. 19 appear in the sheet member 1. Specifically, in each of the side portions 11A to 11F, a plurality of coherent pattern lines CL arranged at intervals in a direction in which the inner peripheral edge portion 4 and the outer peripheral edge portion 5 oppose each other appear. A pair in the coherent pattern lines CL adjacent to each other do not intersect.

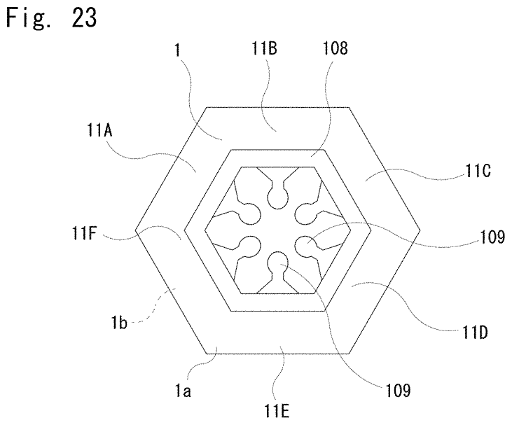

FIGS. 22 and 23 show a modification of the second embodiment. In this modification, the cavity 103 defined by the forming mold 100 includes the land portion 106 arranged inside the product portion 104 and a plurality of gate/runner portions 105 arranged inside the land portion 106. In injection molding, the molten thermoplastic resin flows in one direction from the inner peripheral edge portion 104a toward the outer peripheral edge portion 104b of the product portion 104 as indicated by broken line arrows in FIG. 22. As shown in FIG. 23, in the sheet member 1 taken out from the forming mold 100 after completion of injection molding, the first non-product portion 108 corresponding to the land portion 106 is formed inside the product portion 104, and the second non-product portion 109 corresponding to the gate/runner portion 105 is formed inside the first non-product portion 108.

### Third Embodiment

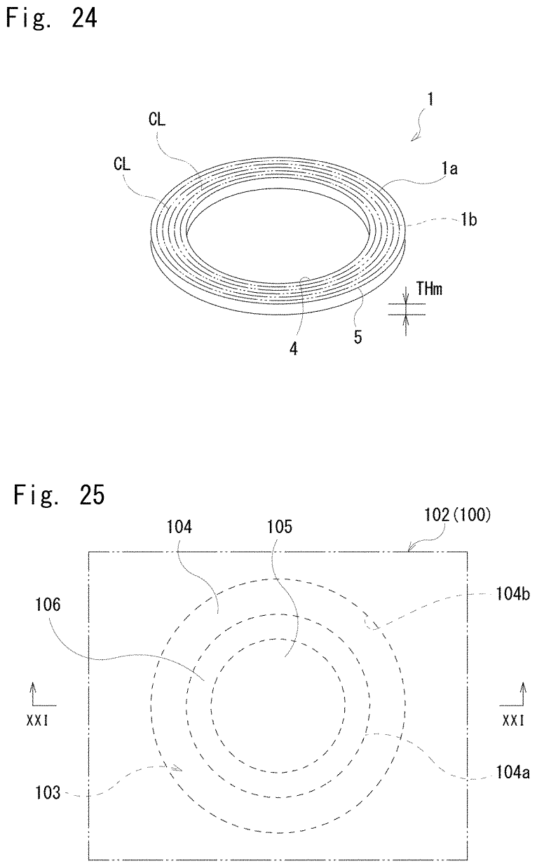

FIG. 24 shows the sheet member 1 according to a third embodiment of the present invention.

The sheet member 1 of the present embodiment has an annular shape. In the present embodiment, the sheet member 1 has a substantially perfect circular shape in plan view, but it may have an elliptical shape in plan view.

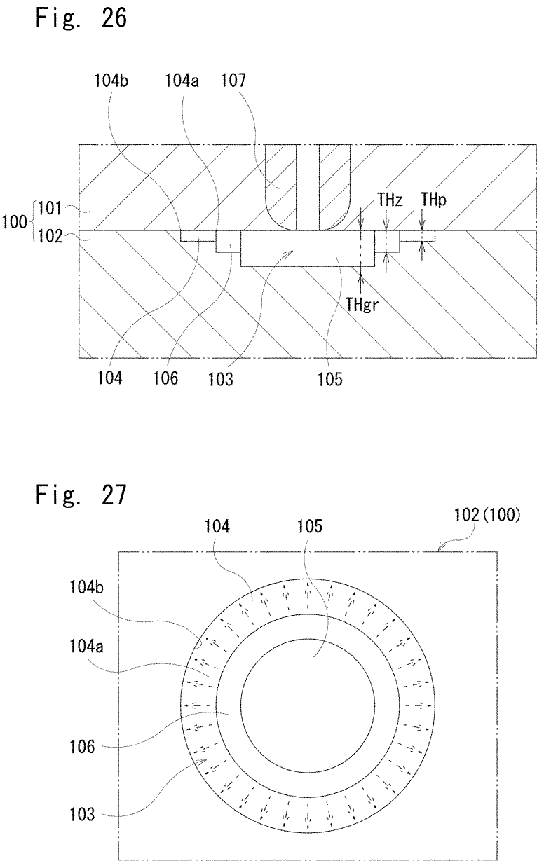

In FIGS. 25 to 27, the forming mold 100 according to the present embodiment is provided with the land portion 106 having an annular shape inside the product portion 104 having an annular shape in plan view. A single gate/runner portion 105 having a cylindrical shape is provided inside the land portion 106. The entire region of the inside of the land portion 106 communicates with the gate/runner portion 105. The molten thermoplastic resin supplied from the molding machine injection unit to the gate/runner portion 105 fills the land portion 106, and then simultaneously flows from the land portion 106 into the product portion 104 as indicated by broken line arrows in FIG. 27.

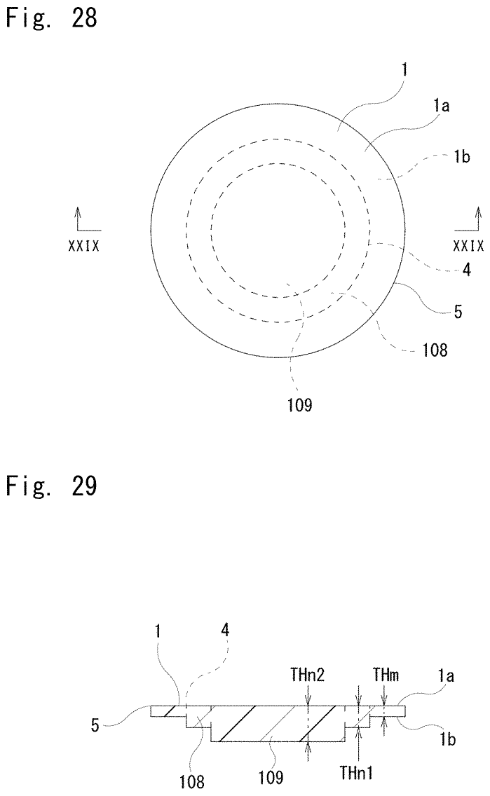

FIGS. 28 and 29 show the sheet member 1 taken out from the forming mold 100 after completion of injection molding. The first non-product portion 108 having an annular shape and corresponding to the land portion 106 is formed outside the sheet member 1, and the second non-product portion 109 having a cylindrical shape and corresponding to the gate/runner portion 105 is formed further outside the first non-product portion 108. By removing the first non-product portion 108 and the second non-product portion 109, manufacturing of the sheet member 1 is completed. However, the sheet member 1 may be used as a finished product without removing the first non-product portion 108 and the second non-product portion 109. When the first non-product portion 108 and the second non-product portion 109 are not removed from the sheet member 1, these portions become thick portions having thicknesses THn1 and THn2 larger than the interval (thickness THm) between the main surfaces 1a and 1b. Such thick portions are preferably 50% or less of the total area of the sheet member 1 in view of ensuring dimensional stability by aligning the orientation of the thermoplastic resin in the portion other than the thick portions of the sheet member 1. The sheet member 1 from which the first non-product portion 108 and the second non-product portion 109 are not removed can be used as a finished product in a modification of the present embodiment described later, as well as other embodiments other than the present embodiment and modifications thereof. The second non-product portion 109 is removed from the sheet member 1, but the sheet member 1 may be used as a finished product without removing the first non-product portion 108.

With the orientation of the thermoplastic resin being aligned in the flow direction of the thermoplastic resin (broken line arrows in FIG. 27) in the product portion 104 of the cavity 103, a plurality of coherent pattern lines CL appear in the sheet member 1 as conceptually indicated by two-dot chain lines in FIG. 24. Specifically, a plurality of coherent pattern lines CL arranged at intervals in a direction in which the inner peripheral edge portion 4 and the outer peripheral edge portion 5 oppose each other appear. A pair in the coherent pattern lines CL adjacent to each other do not intersect.

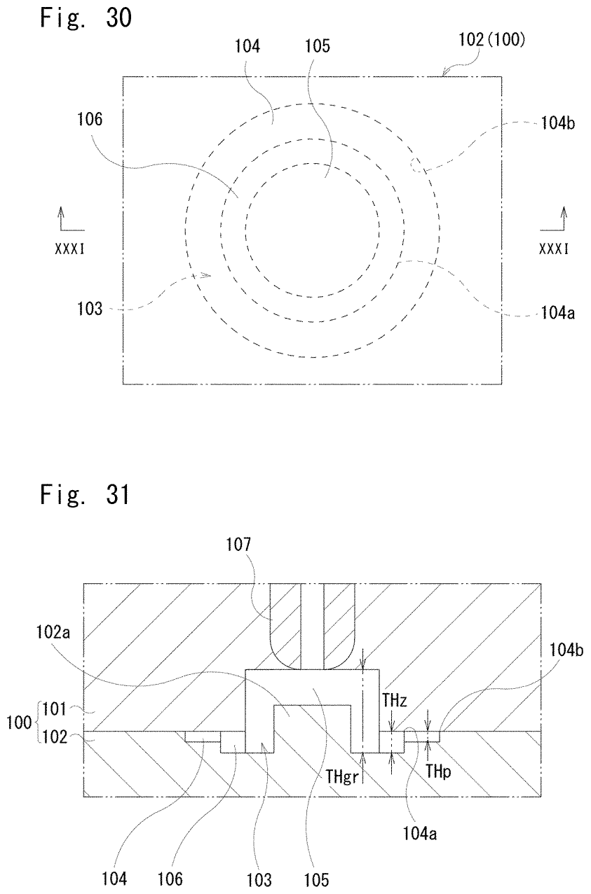

FIGS. 30 to 33 show modifications of the present embodiment.

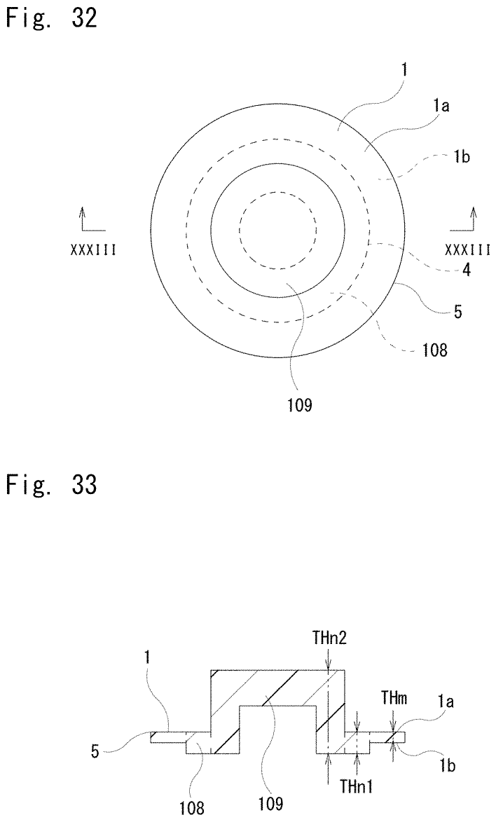

In the modification of FIGS. 30 and 31, the gate/runner portion 105 protrudes upward from the product portion 104 and the land portion 106 in the drawings. The lower mold 102 includes a cylindrical portion 102a protruding upward in the drawings in a portion defining the gate/runner portion 105. Therefore, as shown in FIGS. 32 and 33, the second non-product portion 109 in this modification protrudes upward from the sheet member 1 and the first non-product portion 108 in the drawings and has a shape in which a cylindrical recess is formed at the lower end.

### Fourth Embodiment

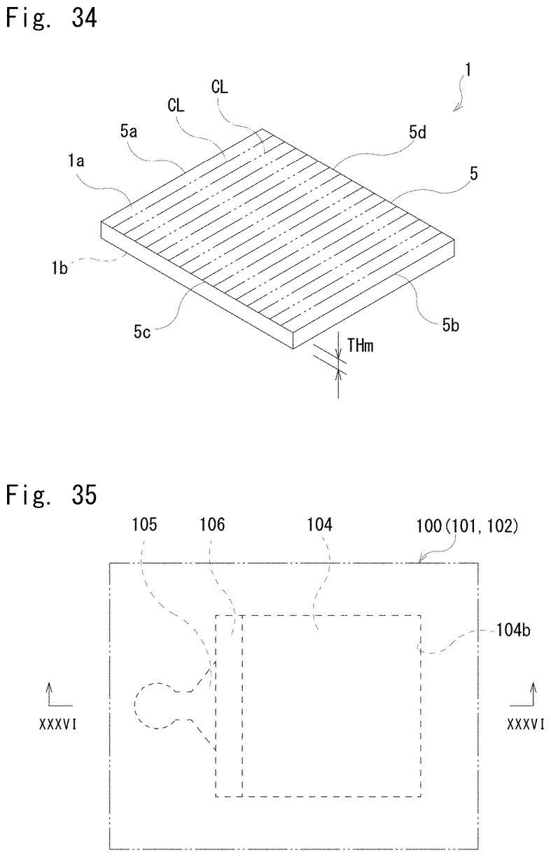

FIG. 34 shows the sheet member 1 according to a fourth embodiment of the present invention.

The sheet member 1 of the present embodiment has a flat rectangular shape. The outer peripheral edge portion 5 of the sheet member 1 includes a pair of straight edge portions 5a and 5b opposing each other and a pair of straight edge portions 5c and 5d opposing each other and connecting end portions of the straight edge portions 5a and 5b.

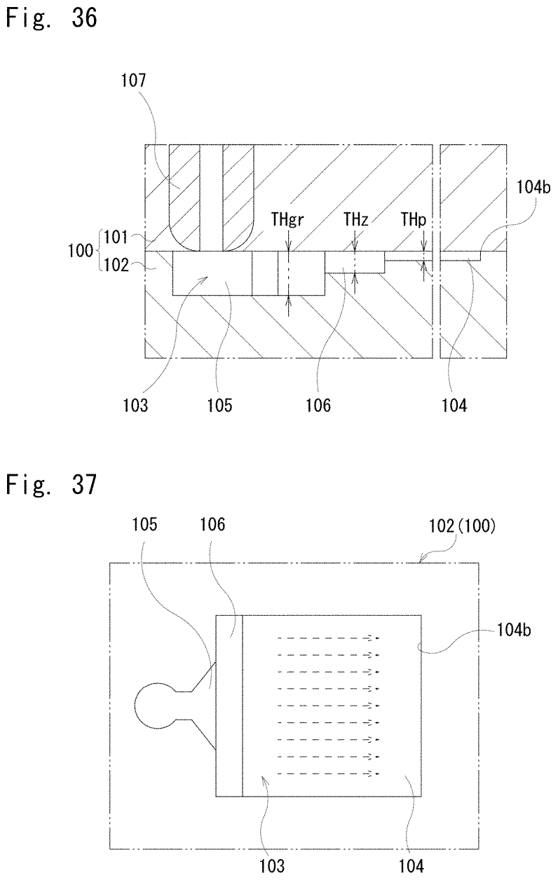

In FIGS. 35 to 37, the forming mold 100 according to the present embodiment is provided with the land portion 106 having an elongated rectangular shape of a constant width at a portion corresponding to the straight edge portion 5a of the product portion 104. A single gate/runner portion 105 is provided on the opposite side of the land portion 106 from the product portion 104. The molten thermoplastic resin supplied from the molding machine injection unit to the gate/runner portion 105 fills the land portion 106, and then simultaneously flows from the land portion 106 into the product portion 104 as indicated by broken line arrows in FIG. 37. More specifically, as indicated by the broken line arrows in FIG. 37, the molten thermoplastic resin flows in one direction from the portion corresponding to the straight edge portion 5a toward the portion corresponding to the straight edge portion 5b of the outer peripheral edge portion 104b of the product portion 104.

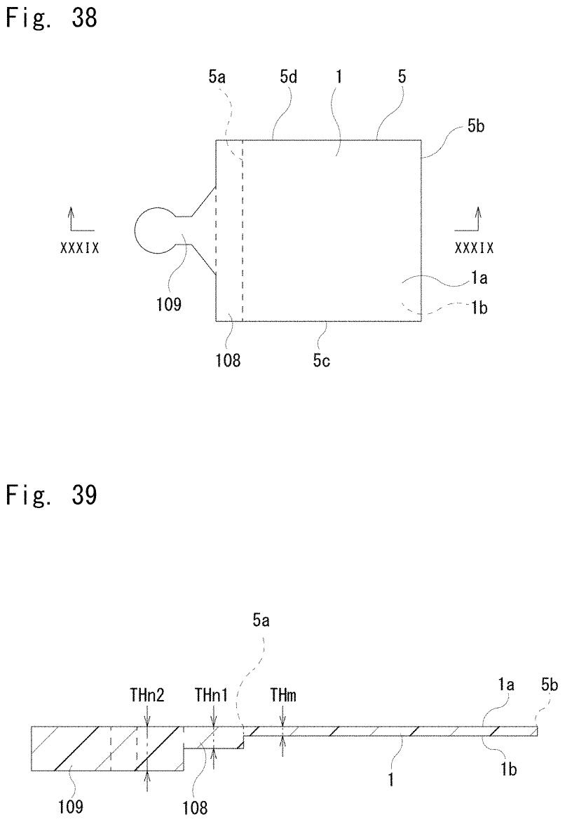

FIGS. 38 and 39 show the sheet member 1 taken out from the forming mold 100 after completion of injection molding. The first non-product portion 108 having an elongated rectangular shape and corresponding to the land portion 106 is formed on the straight edge portion 5a side of the sheet member 1, and the second non-product portion 109 corresponding to the gate/runner portion 105 is formed on the opposite side of the first non-product portion 108 from the sheet member 1.

With the orientation of the thermoplastic resin being aligned in the flow direction of the thermoplastic resin (broken line arrows in FIG. 37) in the product portion 104 of the cavity 103, a plurality of coherent pattern lines CL conceptually indicated by two-dot chain lines in FIG. 34 appear in the sheet member 1. Specifically, a plurality of coherent pattern lines CL arranged at intervals in a direction in which the straight edge portion 5a and the straight edge portion 5b oppose each other appear. A pair in the coherent pattern lines CL adjacent to each other do not intersect.

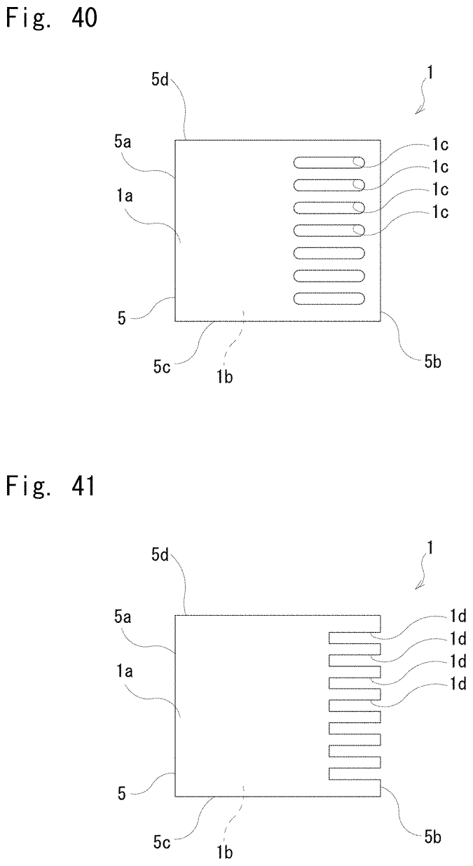

FIGS. 40 and 41 show a modification of the fourth embodiment.

A plurality of through holes 1c are formed in the sheet member 1 of the modification shown in FIG. 40.

In the sheet member 1 shown in the modification shown in FIG. 41, a plurality of notches 1d extending from the straight edge portion 5b toward the straight edge portion 5a and terminating in the sheet member 1 are formed.

A through hole as shown in FIG. 40 and a notch as shown in FIG. 41 may be provided in the sheet member 1 according to an embodiment other than the fourth embodiment.

### Fifth Embodiment

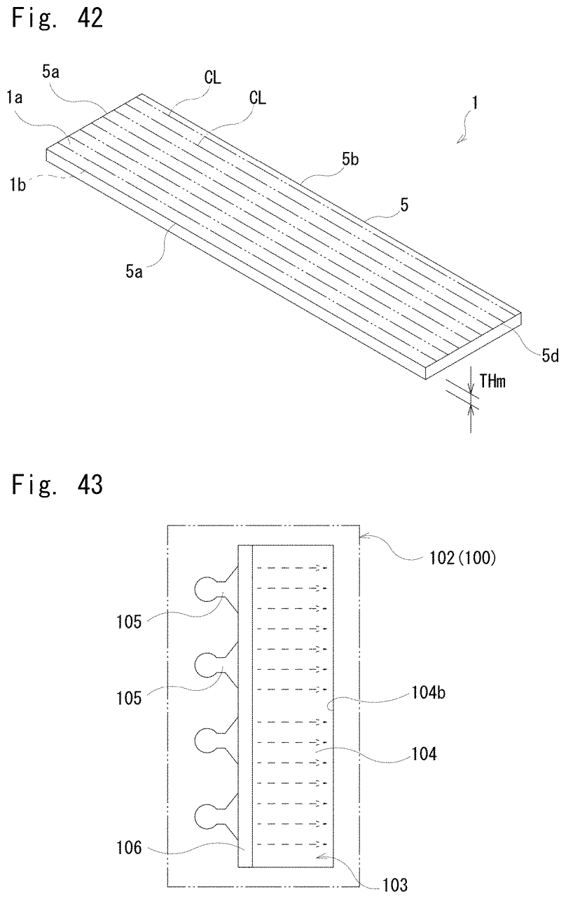

FIG. 42 shows the sheet member 1 according to a fifth embodiment of the present invention.

The sheet member 1 of the present embodiment has a flat rectangular shape as in the fourth embodiment (FIG. 34) but is longer than the sheet member 1 of the fourth embodiment. That is, the straight edge portions 5a and 5b which are parts of the outer peripheral edge portion 5 are sufficiently longer than the straight edge portions 5c and 5d which are also parts of the outer peripheral edge portion 5.

In FIG. 43, the forming mold 100 according to the present embodiment is provided with the land portion 106 having an elongated rectangular shape of a constant width at a portion corresponding to the straight edge portion 5a of the product portion 104. A plurality of gate/runner portions 105 are provided on the opposite side of the land portion 106 from the product portion 104. The molten thermoplastic resin supplied from the molding machine injection unit to the gate/runner portion 105 fills the land portion 106, and then simultaneously flows from the land portion 106 into the product portion 104 as indicated by the broken line arrows. More specifically, the molten thermoplastic resin flows in one direction from the portion corresponding to the straight edge portion 5c toward the portion corresponding to the straight edge portion 5b of the outer peripheral edge portion 104b of the product portion 104.

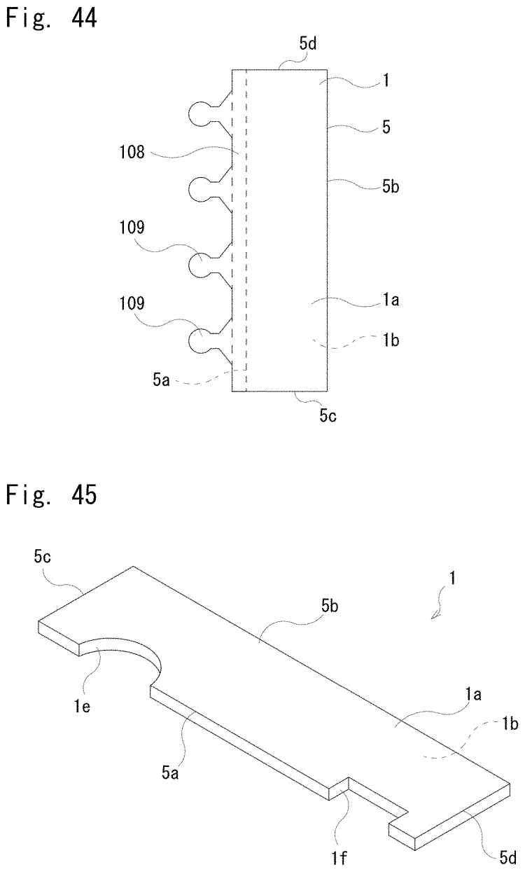

FIG. 44 shows the sheet member 1 taken out from the forming mold 100 after completion of injection molding. The first non-product portion 108 having an elongated rectangular shape and corresponding to the land portion 106 is formed on the straight edge portion 5a side of the sheet member 1, and the second non-product portion 109 corresponding to the gate/runner portion 105 is formed on the opposite side of the first non-product portion 108 from the sheet member 1.

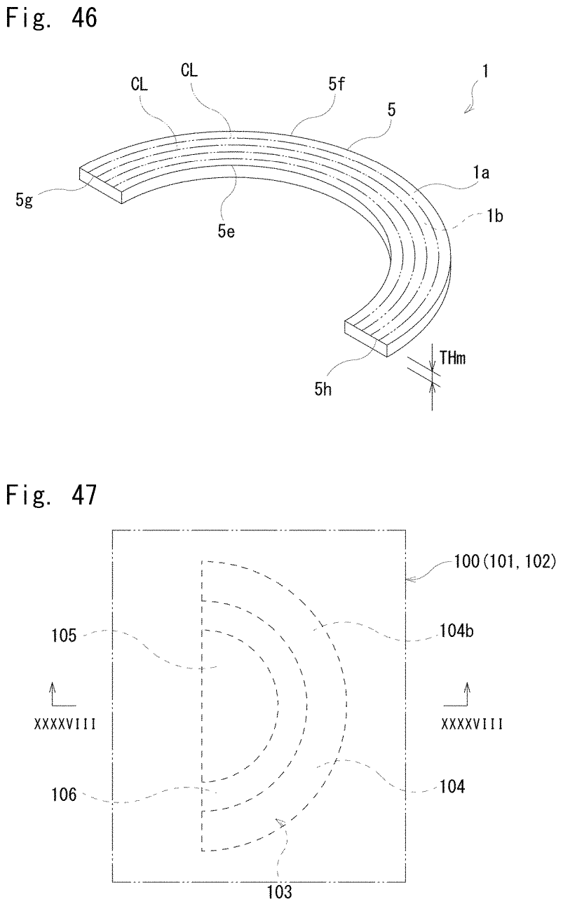

FIG. 45 shows the sheet member 1 according to a modification of the present embodiment. A semicircular notch 1e and a rectangular notch 11 are formed in the straight edge portion 5c of the sheet member 1.

### Sixth Embodiment

FIG. 46 shows the sheet member 1 according to a sixth embodiment of the present invention.

The sheet member 1 of the present embodiment has a semicircular arc shape. The outer peripheral edge portion 5 of the sheet member 1 includes a pair of arcuate edge portions 5e and 5f opposing each other and a pair of straight edge portions 5g and 5h connecting end portions of the arcuate edge portions 5e and 5f.

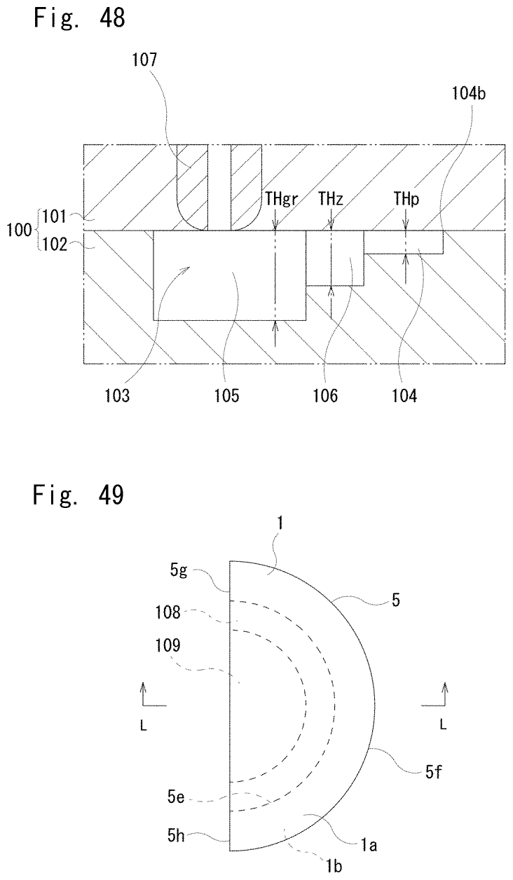

In FIGS. 47 and 48, the forming mold 100 according to the present embodiment is provided with the land portion 106 having a semicircular arc shape of a constant width in a portion corresponding to the arcuate edge portion 5e of the product portion 104. A single gate/runner portion 105 having a semi-cylindrical shape is provided on the opposite side of the land portion 106 from the product portion 104. The molten thermoplastic resin supplied from the molding machine injection unit to the gate/runner portion 105 fills the land portion 106, then simultaneously flows from the land portion 106 into the product portion 104, and then flows in one direction from the portion corresponding to the arcuate edge portion 5e toward the portion corresponding to the arcuate edge portion 5f of the outer peripheral edge portion 104b of the product portion 104.

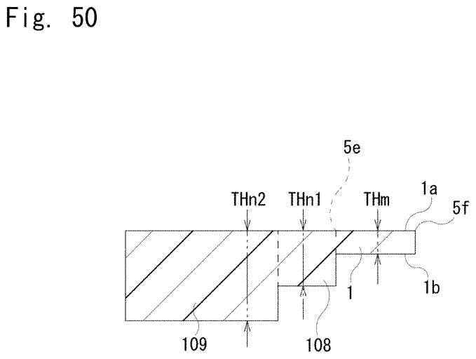

FIGS. 49 and 50 show the sheet member 1 taken out from the forming mold 100 after completion of injection molding. The first non-product portion 108 having an annular shape and corresponding to the land portion 106 is formed on the arcuate edge portion 5e side of the sheet member 1, and the second non-product portion 109 having a semi-cylindrical shape and corresponding to the gate/runner portion 105 is formed on the opposite side of the first non-product portion 108 from the sheet member 1.

With the orientation of the thermoplastic resin being aligned in the flow direction of the thermoplastic resin in the product portion 104 of the cavity 103, a plurality of coherent pattern lines CL conceptually indicated by two-dot chain lines in FIG. 46 appear in the sheet member 1. Specifically, a plurality of coherent pattern lines CL arranged at intervals in a direction in which the straight edge portion 5a and the straight edge portion 5b oppose each other appear. A pair in the coherent pattern lines CL adjacent to each other do not intersect.

### Seventh Embodiment

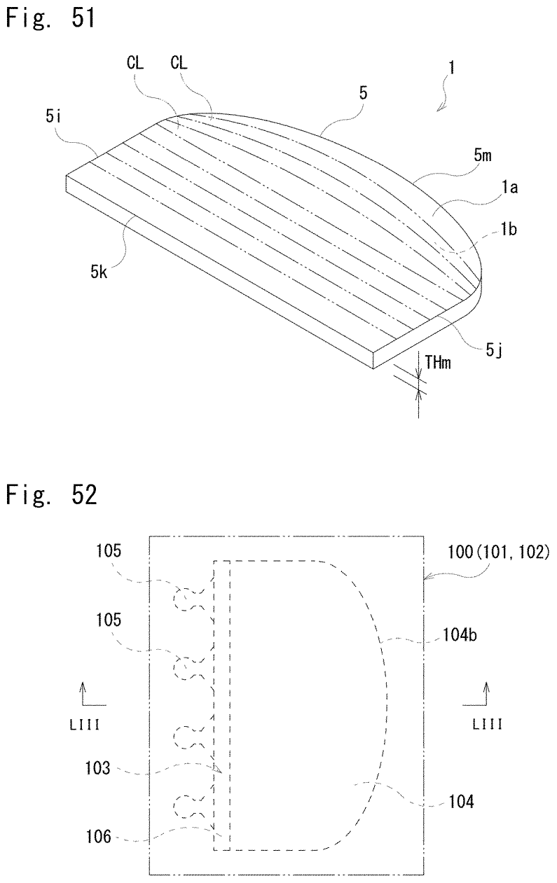

FIG. 51 shows the sheet member 1 according to a seventh embodiment of the present invention.

The outer peripheral edge portion 5 of the sheet member 1 of the present embodiment includes four edge portions similarly to the fourth and fifth embodiments. Specifically, the outer peripheral edge portion 5 of the sheet member 1 includes a pair of relatively short straight edge portions 5i and 5j opposing each other, a relatively long straight edge portion 5k connecting the straight edge portions 5i and 5j, and a curved edge portion 5m opposing the straight edge portion 5k.

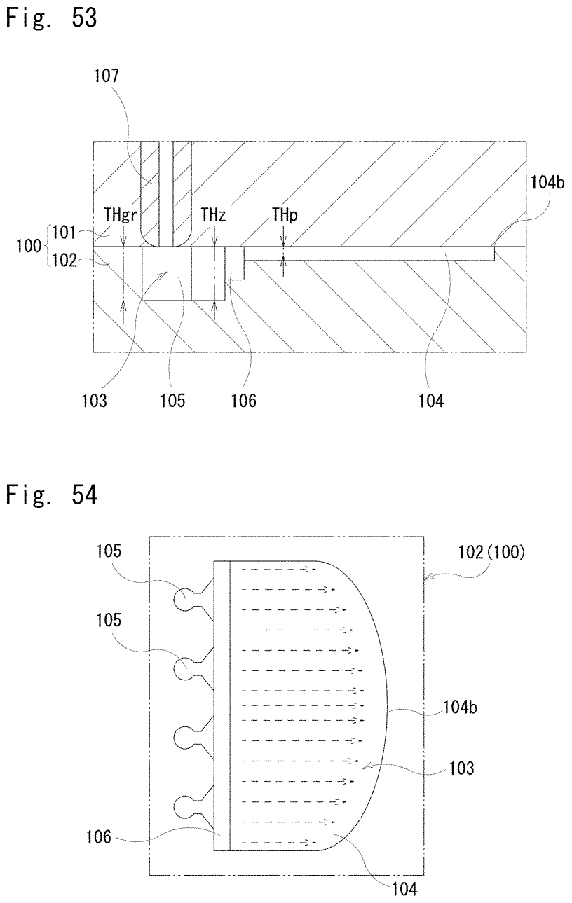

In FIGS. 52 to 54, the forming mold 100 according to the present embodiment is provided with the land portion 106 having an elongated rectangular shape at a portion corresponding to the straight edge portion 5k of the product portion 104. A plurality of gate/runner portions 105 are provided on the opposite side of the land portion 106 from the product portion 104. The molten thermoplastic resin supplied from the molding machine injection unit to the gate/runner portion 105 fills the land portion 106, and then simultaneously flows from the land portion 106 into the product portion 104 as indicated by broken line arrows in FIG. 54. More specifically, the molten thermoplastic resin flows in one direction from the portion corresponding to the straight edge portion 5k toward the portion corresponding to the curved edge portion 5m of the outer peripheral edge portion 104b of the product portion 104.

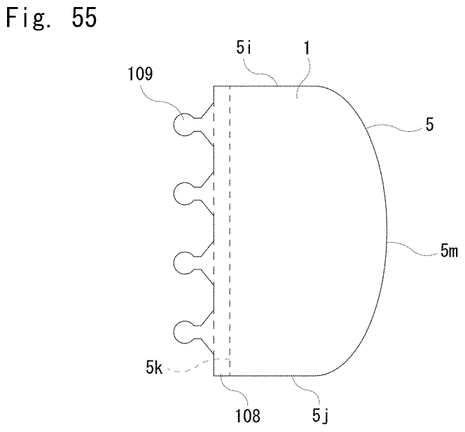

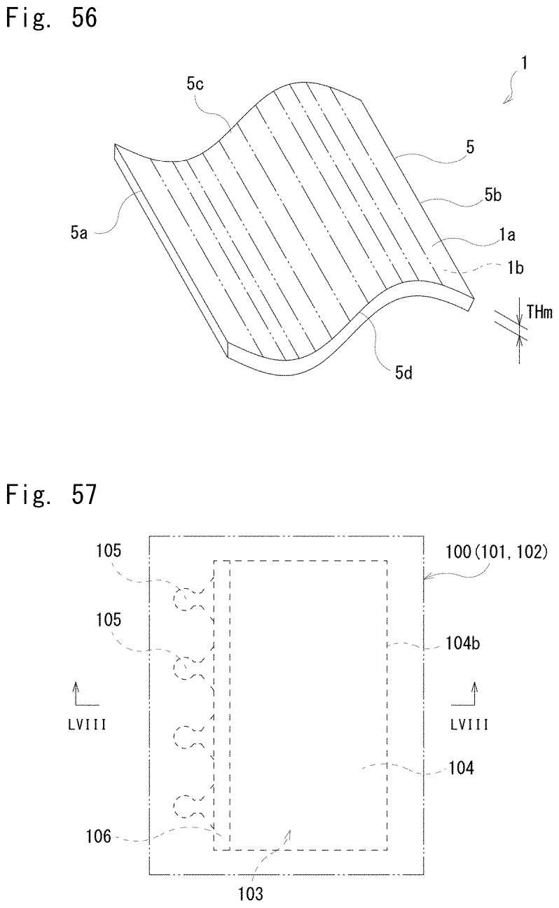

FIG. 55 shows the sheet member 1 taken out from the forming mold 100 after completion of injection molding. The first non-product portion 108 having an elongated rectangular shape and corresponding to the land portion 106 is formed on the straight edge portion 5k side of the sheet member 1, and the second non-product portion 109 corresponding to the gate/runner portion 105 is formed on the opposite side of the first non-product portion 108 from the sheet member 1.

### Eighth Embodiment

FIG. 56 shows the sheet member 1 according to an eighth embodiment of the present invention.

The sheet member 1 of the present embodiment has a rectangular shape as in the fourth and fifth embodiments (FIGS. 34 and 42) when viewed from the opposing direction of the main surfaces 1a and 1b, and the outer peripheral edge portion 5 includes a pair of straight edge portions 5a and 5b and another pair of straight edge portions 5c and 5d connecting the pair of straight edge portions 5a and 5b. While the sheet member 1 of the fourth and fifth embodiments (FIGS. 34 and 42) is flat, the sheet member 1 of the present embodiment is curved and has a curved surface shape. In the present embodiment, the sheet member 1 has a curve only in a direction in which the straight edge portions 5a and 5b oppose each other. However, the sheet member 1 may have a three-dimensional curved surface shape.

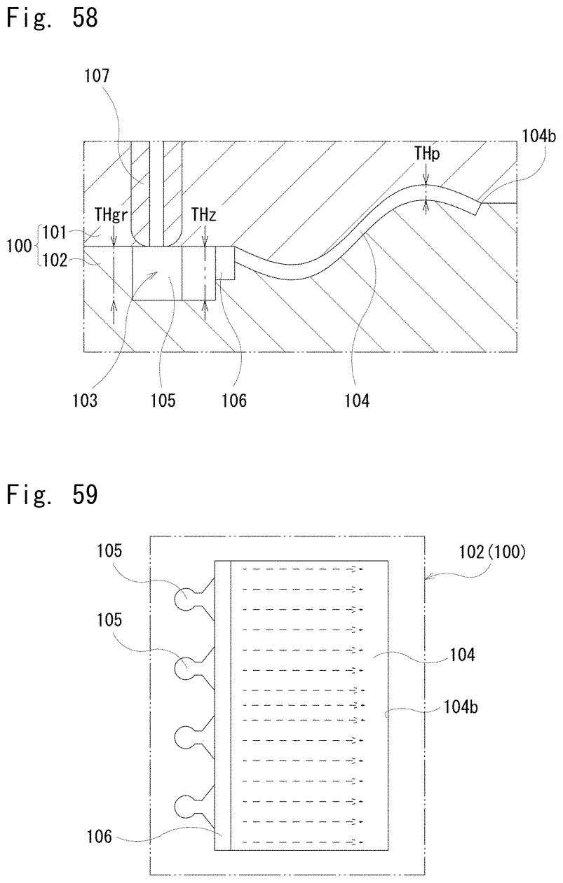

In FIGS. 57 to 59, the forming mold 100 according to the present embodiment is provided with the land portion 106 having an elongated rectangular shape of a constant width at a portion corresponding to the straight edge portion 5a of the product portion 104. A plurality of gate/runner portions 105 are provided on the opposite side of the land portion 106 from the product portion 104. The molten thermoplastic resin supplied from the molding machine injection unit to the gate/runner portion 105 fills the land portion 106, and then simultaneously flows from the land portion 106 into the product portion 104 as indicated by broken line arrows in FIG. 59. More specifically, as indicated by broken line arrows in FIG. 59, the molten thermoplastic resin flows in one direction from the portion corresponding to the straight edge portion 5a toward the portion corresponding to the straight edge portion 5b of the outer peripheral edge portion 104b of the product portion 104.

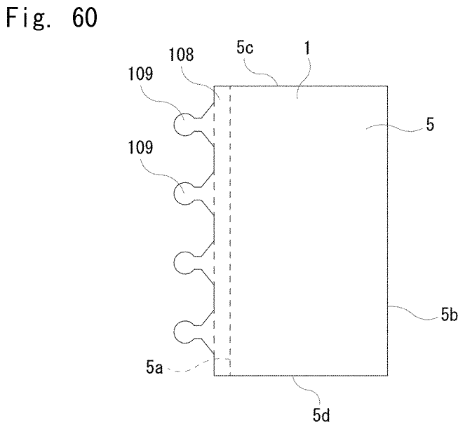

FIG. 60 shows the sheet member 1 taken out from the forming mold 100 after completion of injection molding. The first non-product portion 108 having an elongated rectangular shape and corresponding to the land portion 106 is formed on the straight edge portion 5a side of the sheet member 1, and the second non-product portion 109 corresponding to the gate/runner portion 105 is formed on the opposite side of the first non-product portion 108 from the sheet member 1.

With the orientation of the thermoplastic resin being aligned in the flow direction of the thermoplastic resin (broken line arrows in FIG. 59) in the product portion 104 of the cavity 103, a plurality of coherent pattern lines CL conceptually indicated by two-dot chain lines in FIG. 56 appear in the sheet member 1. Specifically, a plurality of coherent pattern lines CL arranged at intervals in a direction in which the straight edge portion 5a and the straight edge portion 5b oppose each other appear. A pair in the coherent pattern lines CL adjacent to each other do not intersect.

(Evaluation Test)

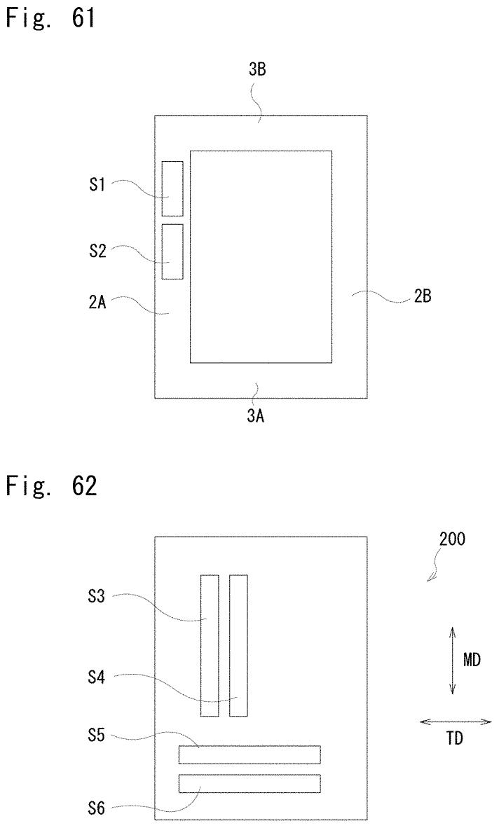

An evaluation test for verifying the dimensional stability of the gasket 4 according to the first embodiment was performed. Six samples were used in this evaluation test. As shown in FIG. 61, samples S1 and S2 are cut out from the longer portion 2A of the gasket 1 according to an embodiment (Example). As shown in FIG. 62, samples S3 to S6 are cut out from a thin resin film 200 that has been extruded (Comparative Example). The samples S3 and S4 are elongated in the flow direction (MD direction) of the resin in the extrusion molding, and the samples S5 and S6 are elongated in the direction (TD direction) orthogonal to the MD direction.

The sample S1 to S6 were placed in an environment of 80t for 3 days, and the initial length and the length after 3 days were measured. The results of the evaluation test are shown in Table 2 below.

TABLE 2

| | Example | | | | Comparative Example | | | |
|---|---|---|---|---|---|---|---|---|
| | Longer direction | | Shorter direction | | MD direction | | TD direction | |
| | Sample S1 | Sample S2 | Sample S1 | Sample S2 | Sample S3 | Sample S4 | Sample S5 | Sample S6 |
| Initial length | 40.09 | 40.07 | 15.05 | 15.21 | 100.18 | 99.62 | 100.16 | 100.24 |
| (mm) | | | | | | | | |
| Length after 3 | 39.89 | 39.95 | 15.00 | 15.13 | 99.10 | 98.80 | 99.20 | 99.43 |
| days (mm) | | | | | | | | |
| Shrinkage | 0.20 | 0.12 | 0.05 | 0.08 | 1.08 | 0.82 | 0.96 | 0.81 |
| amount (mm) | | | | | | | | |
| Shrinkage | 0.50 | 0.30 | 0.33 | 0.53 | 1.08 | 0.82 | 0.96 | 0.82 |
| ratio (%) | | | | | | | | |

| | | | | |
|---|---|---|---|---|
| Average | 0.40 | 0.43 | 0.95 | 0.88 |
| Standard | 0.10 | 0.10 | 0.13 | 0.08 |
| deviation | | | | |

In the samples S1 and 2 of Example, the shrinkage ratio is less than 0.6% in both the longer direction and the shorter direction, whereas in the samples S3 and S4 of Comparative Example, the shrinkage ratio is more than 0.8% in both the MD direction and the TD direction. The test results indicate that the gasket 1 of the present embodiment manufactured by injection molding has excellent dimensional stability as compared with a gasket made of extruded thin resin film.

The present invention can also be applied to other thin resin sheet members such as gaskets and separators for other batteries such as nickel hydrogen batteries in addition to a fuel cell gasket.

### REFERENCE SIGNS LIST

1: Thin resin sheet member (sheet member), 1a; 1b: Main surface, 1c: Through hole, 1d; 1e; 1f: Notch, 2A; 2B: Longer portion, 3A; 3B: Shorter portion, 4: Inner peripheral edge portion, 5: Outer peripheral edge portion, 5a, 5b, 5c, 5d: Straight edge portion, 5e, 5f: Arcuate edge portion, 5g; 5h: Straight edge portion, 5i; 5j; 5k: Straight edge portion, 5m: Curved edge portion, 11A; 11B; 11C; 11D; 11E; 11F: Side portion, 100: Forming mold, 101: Upper mold, 102: Lower mold, 102a: Cylindrical portion, 103: Cavity, 104: Product portion, 104a: Inner peripheral edge portion, 104b: Outer peripheral edge portion, 105: Gate/runner portion, 105a: Gate portion, 105b: Runner portion, 106: Land portion, 107: Spool, 108: First non-product portion, 109: Second non-product portion, 110: Spool bush, 110a: Spool, 112: Overflow portion, 113: Third non-product portion

1. A thin resin sheet member comprising a pair of main surfaces opposing each other,
wherein the thin resin sheet member has a maximum thickness of 40 μm or more and 450 μm or less, the maximum thickness being a maximum interval between the pair of main surfaces, and
the thin resin sheet member has a region in which a plurality of coherent pattern lines appear when viewed from a direction facing the pair of main surfaces, the plurality of coherent pattern lines being arranged at intervals in a direction in which one edge portion and another edge portion opposing the one edge portion oppose each other, and a pair in the plurality of coherent pattern lines adjacent to each other do not intersect.

2. The thin resin sheet member according to claim 1, wherein the region is 50% or more of a total area of the pair of main surfaces.

3. The thin resin sheet member according to claim 1, the thin resin sheet member being formed by injection of a thermoplastic resin.

4. The thin resin sheet member according to claim 3, wherein the thermoplastic resin has a melt mass flow rate of 1 g/10 min or more and 300 g/10 min or less and a heat of fusion of 0 mj/mg or more and 150 mj/mg or less.

5. A method for manufacturing a thin resin sheet member, the method comprising:
preparing a forming mold defining a cavity including a product portion in which a thin resin sheet member is molded, a gate/runner portion communicating with a molding machine injection unit, and a land portion communicating with the gate/runner portion and communicating with one edge portion of the product portion, wherein the land portion has a thickness larger than a thickness of the product portion; and
supplying a molten resin from the molding machine injection unit to the gate/runner portion, wherein after the molten resin fills the land portion, the molten resin flows from the one edge portion into the product portion and flows toward another edge portion opposing the one edge portion of the product portion.

6. The method for manufacturing a thin resin sheet member according to claim 5, wherein the thickness of the land portion is 1.3 times or more and 24 times or less the thickness of the product portion.

7. The method for manufacturing a thin resin sheet member according to claim 5, wherein the land portion has an average thickness of 300 μm or more and 1200 μm or less.

8. The method for manufacturing a thin resin sheet member according to claim 5, wherein
the land portion communicates with an entire region of an inner peripheral edge portion of the product portion, and
after the molten resin fills the land portion, the molten resin flows from the inner peripheral edge portion into the product portion and flows toward an outer peripheral edge portion of the product portion.

9. The method for manufacturing a thin resin sheet member according to claim 5, wherein
the land portion communicates with an entire region of an outer peripheral edge portion of the product portion, and
after the molten resin fills the land portion, the molten resin flows from the outer peripheral edge portion into the product portion and flows toward an inner peripheral edge portion of the product portion.

10. The method for manufacturing a thin resin sheet member according to claim 5, wherein
the product portion has an outer peripheral edge portion including a plurality of edge portions,
the land portion communicates with one edge portion constituting a part of the outer peripheral edge portion of the product portion, and
after the molten resin fills the land portion, the molten resin flows from the one edge portion toward another edge portion opposing the one edge portion constituting a part of the outer peripheral edge portion.

11. The method for manufacturing a thin resin sheet member according to claim 5, wherein the resin is a thermoplastic resin having a melt mass flow rate of 10 g/10 min or more and 300 g/10 min or less and a heat of fusion of 0 mj/mg or more and 150 mj/mg or less.
